(19) United States
(12) Patent Application Publication
(10) Pub. No.: US 2026/0327123 A1
(43) Pub. Date: Oct. 22, 2026

(54) APPARATUS AND PROCESS FOR PRODUCING GLASS

(71) Applicant: Schott AG, Mainz (DE)

(72) Inventors: Tamara Golubeva, Mainz (DE); Michael Hahn, Mainz (DE); Günter Weidmann, Mainz (DE); Stefan Bauer, Mainz (DE); Volker Ohmstede, Mainz (DE)

(73) Assignee: Schott AG, Mainz (DE)

(21) Appl. No.: 19/130,705

(22) PCT Filed: Nov. 16, 2023
(86) PCT No.: PCT/EP2023/081995

§ 371 Date: May 16, 2025

(30) Foreign Application Priority Data
Nov. 18, 2022 (DE) 10 2022 130 588.0
Nov. 16, 2023 (WO) PCTEP2023081995

(51) Int. Cl. C03B 3/02; C03B 5/02; C03B 5/027; C03B 5/167

(52) U.S. Cl. CPC C03B 3/023; C03B 5/023; C03B 5/027; C03B 5/1675

(57) ABSTRACT

The invention relates to an apparatus for producing glass and to a process which can be executed with the apparatus.

### CROSS-REFERENCE TO RELATED APPLICATIONS

This application is a national stage entry under 35 U.S.C. § 371 of International Patent Application No. PCT/EP2023/081995 entitled “APPARATUS AND PROCESS FOR PRODUCING GLASS” filed on Nov. 16, 2023, which is incorporated in its entirety herein by reference. International Patent Application No. PCT/EP2023/081995 claims priority to German Patent Application No. 10 2022 130 588.0 filed on Nov. 18, 2022, which is incorporated in its entirety herein by reference.

### BACKGROUND OF THE INVENTION

### 1. Technical Field of the Invention

The invention relates to an apparatus for producing glass and to a process which can be executed with the apparatus.

### 2. Description of the Related Art

Continuous glass melting tanks are conventionally heated industrially with burner technologies. For the combustion in the corresponding burners, fossil fuels such as natural gas and/or oil are used, with consequent release of CO₂ and additionally, when using air, of NOₓ as discharged gas. Candidates to substitute for fossil fuels for the heating of glass tanks include not only hydrogen gas but also electrical energy produced via regenerative energies, an example being the heating of the batch and/or of the glass melt with microwave energy.

The technologies addressed in a section of the prior art describe discontinuous crucible melting and address heating with microwaves.

DE 10 2016 205 845 A1 discloses microwave heating, among others, for a preliminary reaction of batch. A disadvantage, however, is that in this temperature range in particular, only very little of the microwave radiation is absorbed by the batch, and the heating performance in this case is highly inefficient.

CN 203128388 U and CN 201210552723 describe a burner-heated glass melting tank with microwave emitters in the superstructure that are used for the destruction of foam.

WO 2006 059576 A claims a microwave-assisted reduced-pressure refining chamber.

US2004056026 A describes a cascade tank with multiple crucibles in series, which are situated in serially arranged microwave resonators heated via microwave radiation.

In the specifications stated above, the microwave acts in each case on the total melt volume and there is substantially no directed heating. A key parameter is the power density dissipated in the melt (W/m³).

During the glass melting operation, i.e. the transformation of a granular batch into a glass melt, one problem is that the transformation zone generally can be heated not directly but instead only indirectly by convection, thermal conduction and thermal radiation. It is known, though, that the properties of this transformation zone, such as the temperature distribution therein and the residence time of the resultant glass in particular sections of the melting equipment, are greatly important to the glass quality.

WO 2021/175506 describes a glass melting process wherein microwave radiation is used for at least part of the energy supplied for melting for the transformation of a batch into a glass melt.

US2019/0295734 describes a process for fusing radioactive wastes into a glass matrix, the process being assisted by microwave heating. Production of a homogeneous, defect-free glass which is later available for other applications is not described in that patent application.

### SUMMARY OF THE INVENTION

It is an object of the invention, accordingly, to provide an apparatus and a process with which the transformation zone can be heated directly to the desired temperature distribution without substantial alteration to the temperature distribution in lower zones of the glass melt. A further object is to provide a process and an apparatus with which convection in the overall melt can be optimized in a targeted way in order to produce an extremely homogeneous and streak-free glass which ought, moreover, to be free from bubbles and inclusions.

Provided in particular is an apparatus for producing glass, comprising a charging region and a melting region,
the charging region comprising at least one microwave-emitting source, more particularly at least one microwave radiator, and at least one waveguide capable of guiding microwave radiation 13 from a microwave generator into the vicinity of a batch layer 17, and
the charging region being designed such that no microwave radiation can leave the charging region.

Provided according to a further aspect is a process for producing glass, comprising a charging region and a melting region,
the charging region comprising at least one microwave-emitting source, more particularly at least one microwave radiator, and at least one waveguide capable of guiding microwave radiation 13 from a microwave generator into the vicinity of a batch layer 17, and
the charging region being designed such that no microwave radiation can leave the charging region.

Such process may further comprise the following steps:
heating the batch until a melt is obtained, more particularly wherein the batch at least in sections is heated to a temperature above T3, corresponding to a molten glass viscosity of 10³ dPa*s, and/or
refining the melt, wherein the melt is heated at least in sections to a temperature above T2.5, corresponding to a molten glass viscosity of 10^{2.5} dPa*s, and/or obtaining a refined glass, a refined glass-ceramic or a refined glass which can be ceramized to glass-ceramic.

### BRIEF DESCRIPTION OF THE DRAWINGS

FIG. 1 shows a schematic representation of an embodiment of the apparatus of the invention; and

FIG. 2 shows a vertical profile of the power density for an electrical conductivity of 20 S/m and an MW frequency of 2.45 GHZ, the maximum value is situated at around 35.106 W/m³; the entire microwave (MW) power is absorbed in a layer thickness of 17 mm.

In the description below, identical reference symbols in the figures each denote identical or equivalent constituents or functional elements. For the sake of better understanding, however, the figures are not represented to scale, unless they involve the diagrammatic two-dimensional representation of respective data quantities.

### DETAILED DESCRIPTION OF THE INVENTION

### Definitions

The concept, as used in the context of the present disclosure, of the microwave or of microwave radiation is to start with, and thus without further, clarifying definition, a trivial name for electromagnetic waves having a frequency which in the older literature was indicated as ranging from 1 to 300 GHZ, corresponding to a wavelength of about 30 cm to 1 mm in a vacuum. Other, more recent references in the literature indicate even wider limits for the frequency range, for example from 300 MHz to about 1 THz. For the purposes of the present disclosure, microwaves are understood by definition, in accordance with more recent literature figures, to refer to electromagnetic waves having a frequency from 300 MHz to about 1 THz.

High frequencies typically used (>30 GHZ) are not preferred, however, since the depth of penetration by the microwave radiation into the glass melt in that case is extremely low and the risk of overheating is too high. With microwaves in the region around 2 GHZ, conversely, the risk of overheating is a lot smaller and the microwave has a greater depth of penetration into the glass melt.

For the purposes of the present disclosure, the concepts of microwave radiation and of the microwave are used synonymously and each refer to the same electromagnetic waves as defined above.

Coupling-in is understood to be the interaction of the microwave radiation with the first liquid-melt phase, both when present in the batch as a solid in this first melting phase and when present in liquid form.

In the manner customary in the art, the batch comprises those constituents of the subsequently melted glass that are present in solid form before being charged to the glass melt, while the unrefined melt is the molten batch which has not yet undergone further refining, more particularly advanced refining (German: Feinläuterung).

Illustratively, and without restriction as to the general definition, the batch, as well as comprising customary starting materials in powder form, may also comprise glass-ceramic and/or else borosilicate glasses, and cullet contents of 20% to 50%.

In the context of the present disclosure, the concept of melting as a generic term also encompasses the processes of melt production and of melting down. Melt production is understood as the process of melting at least parts of a batch present in solid form, this batch undergoing transition from its solid physical state into a liquid physical state, as described in more detail below and defined for the purposes of the present disclosure. Melting down refers to the complete conversion of a batch initially present in solid form into its liquid state, particularly its conversion into the unrefined glass melt.

The melting reaction zone in the context of the present disclosure refers to a three-dimensional boundary region or transition region in which on one side of this boundary, the batch is still present in a solid form, while on the other side of this boundary or transition region, melt production is already occurring, or melts are already being produced, and the batch undergoes transition in particular into a liquid state. The first liquid phases are formed by the melting salts, e.g. Na₂CO₃, B₂O₃, at their respective melting point, in which they reactively dissolve the other components of the batch.

“Unrefined (glass) melt” is a technical term from glass technology and refers to the melt prior to refining. It is the first liquid-melt or molten phase, in which all of the raw materials have undergone transition to the liquid state but bubbles are still contained in the melt.

The unrefined melt is heated to a glass viscosity of less than or equal to 10¹³ dPas, but at least 10² dPas overall. Beyond this value for the viscosity, the molten glass, in particular for lower viscosity values, is assumed to be present in liquid-melt or liquid form.

The extent of the melting reaction zone amounts generally to a few millimetres and is dependent on the electrical conductivity of the glass and the frequency of the microwave chosen. The melting zone may extend over a depth of about 1 mm to 100 mm, preferably 1 to 50 mm, more preferably 1 to 20 mm, in the radiant direction of the microwave radiation. Because of the absorption of the microwave radiation in these low depths, power densities of 10 to 100 W/cm³ (10 W/cm³=10 000 000 W/m³=10⁷ W/m³=10 000 kW/m³) are achievable. For example, the microwave can be absorbed in a layer thickness of less than 20 mm in the glass melt. In this case it is possible to achieve power densities of well above 10⁷ W/m³. According to some embodiments, the microwave is absorbed in a layer thickness of only 1 to 10 mm. To achieve such depths of penetration into the glass, depending on the electrical conductivity of the particular glass melt, the invention uses microwaves having frequencies of, for example, 2.45 GHZ, more preferably 940 MHz or 500 MHz.

A “bubble” is a gaseous inclusion within a glass or a glass melt that possesses a diameter of in general at least 10 μm. The “diameter” here denotes the spherical equivalent diameter. Where this description refers to the “size” of a bubble, the spherical equivalent diameter is meant. Within this description, the term “bubble” may be understood both as a gaseous inclusion in the broadest meaning, and also as a “CO₂ bubble” or “O₂ bubble” in a particular meaning.

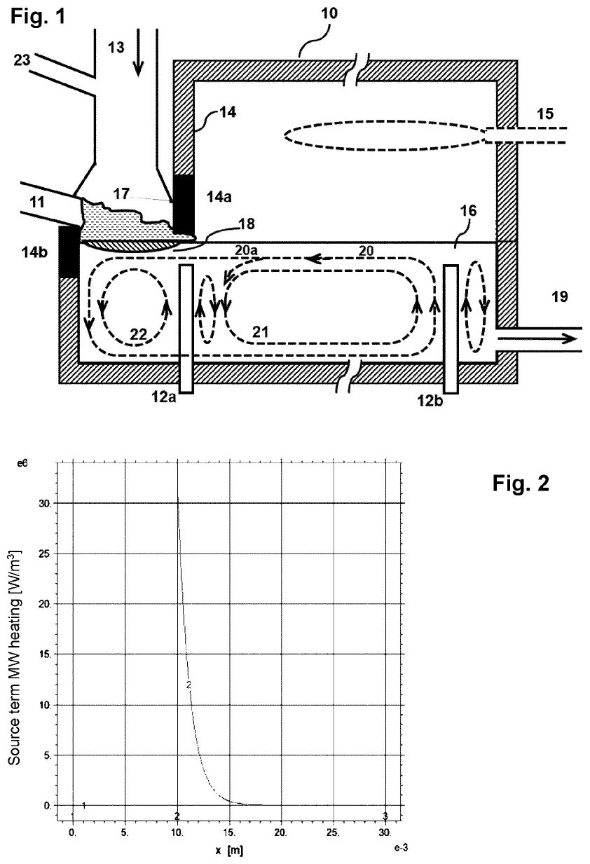

FIG. 1 shows a schematic representation of an apparatus 10 for melting glass according to one variant of the invention and is suitable for performing the process of the invention. The representation is a section through the glass melting tank in the glass flow direction from charging zone to glass melt outlet.

Even if not explicitly represented, the apparatus comprises all of the supply facilities needed for the melting of glass, including, in particular, electrical supply facilities which are able to supply electrical power.

The apparatus 10 comprises a melting tank which has walls consisting of refractory material and accommodating not only the batch 17 to be melted but also the molten batch in the form of molten glass 16 and hence of glass melt 16. The region above the glass melt 16, which forms the roof or superstructure of the melting tank 10, is referred to as the top furnace.

The region above the glass melt 16 is divided into two separate regions, the first being the charging region, also called doghouse, and the other the actual melting region, i.e. the space beneath the superstructure of the melting tank 10. In the charging region, the batch is charged preferably via a charging duct 11 into the charging region and the charged batch preferably forms a continuous batch layer 17 on the surface of the glass melt in the charging region. In particular, the charging region is separate, in a “microwave-proof” or “microwave-shielding” manner, from the melting region, the charging region thus being designed such that no microwave radiation can pass from the charging region into the melting region. The glass melt 16 absorbs the microwave; accordingly, measures to prevent the microwave escaping from the charging region need be taken only above the glass melt. Illustrative measures are described below.

The walls of the melting tank have cooling arrangement preferably in at least one region 14a and/or 14b. The wall regions may be cooled by means of cooling fluids such as air or gases, water and/or cooling liquids such as thermal oil, for example. Thermal oil comprises mineral, silicone-based or synthetic oils which are employed for the cooling and heating of industrial plants and processes.

Cooling in the wall region 14a can shield the batch layer 17 from the heat emitted radiantly by the melting tank and the glass melt, and so there is no glassy layer on top of the batch layer is formed, on or in the top region of the batch layer, that might absorb microwave radiation before it reaches the lower region of the batch layer adjacent to the melting zone 18. The top portion of the batch layer therefore remains sufficiently cool, so that the batch is in solid form and does not absorb microwave radiation. Alternatively, on the side facing the microwave radiation, the wall region 14a may have a microwave-reflective metallic coating, for example a Pt coating, which may have a similar effect.

The wall region 14a reaches further to into the batch layer 17 and thereby shields the interior of the melt tank from the charging region and thus from the microwave radiation. The surface of the glass melt 16 preferably reaches to close to the bottom side of the wall 14. The distance from the surface of the melt to the bottom side of the wall 14 is preferably at most 10, for example 5 to 7 mm. According to one embodiment of the invention, the charging of the batch is regulated such that in the charging region, a continuous batch layer 17 lying on the glass melt is formed and such that the batch layer lying 17 on the glass melt extends at least to the bottom side of the wall 14 and so provides the charging region with microwave shielding in the direction of the top furnace of the melting tank. An arrangement of this kind is able to prevent penetration of microwaves into the melting region of the melting tank, and the microwave radiation is limited to the charging region.

Preferably, moreover, the batch layer does not reach into the actual melting region of the melting tank 10 behind the wall 14, and so the melting of the batch is confined entirely to the charging region.

In the charging region, the surface of the glass melt 16 is covered preferably entirely by the batch layer or batch carpet 17. This has the advantage on the one hand that the glass melt is thermally insulated even in the cooler melting down region and so exhibits less heat loss. On the other hand, the region of the charging zone located above the batch layer is also shielded from the heat of the glass melt.

The surface of the batch layer is largely not electrically conducting and is therefore not heated by the microwave radiation except in the immediate vicinity of the glass melt. The heating of the batch/of the lowermost batch layer takes place therefore indirectly, through the heated melting zone 18.

Furthermore, preferably, the thickness and dielectric properties of the batch layer are regulated such that it can be utilized as an antireflection layer for the microwave radiation introduced into the glass melt, in order to reduce any reflection losses accompanying the coupling of the microwave into the glass melt. In order to produce such an effect, according to one such embodiment, the layer thickness of the batch layer corresponds preferably to a quarter of the wavelength of the irradiated microwave radiation in the batch, or to a multiple thereof.

Cooling in the wall region 14b may increase the durability of the refractory material in this wall region. The wall region 14b is located close to the melting zone 18 and is therefore exposed to a high thermal load. Cooling in the wall region 14b prevents a high thermal load on the refractory material of the wall region.

The batch/the glass melt is heated by at least one microwave radiator 13, by resistance heating, more particularly electrodes or electrode arrays 12a and 12b, and optionally by gas burners or gas flames, respectively, 15 in the top region or superstructure of the melting furnace. According to one preferred embodiment of the invention, the melting tank is operated as an all-electric melting tank, i.e. substantially by means exclusively of resistance heating and microwave radiators. If the electrical energy used for melting is provided by electrical power having an at least neutral CO₂ balance, it is possible to provide a CO₂-neutral glass melting process in which the input of energy in the melting zone is accomplished exclusively with electrical energy, more particularly by means of resistance heating and microwave irradiation.

The batch 17 is charged in solid form, via charging screws known to the skilled person or through a “microwave-proof” or “microwave-shielding” aperture via a charging duct 11, each of which is designed such that no microwave energy can be emitted to the outside.

The microwave radiation 13 is irradiated as described above such that it is absorbed in the melting reaction zone 18, being therefore coupled into said zone, which is consequently heated. This radiation is generated, for example, by one or more magnetrons (434 MHz, 500 MHz, 915 MHz and/or 2.45 GHz), which are accommodated outside the melting tank, in what is called the “doghouse”, for example. In principle, heating with gyrotrons and magnetrons and also other microwave frequencies would also be possible.

The microwave radiation is guided via one or more waveguides from one or more microwave generators into the vicinity of the batch layer 17. Examples of possible waveguides used are horns and/or cylinder-like apparatuses. The microwave radiation is preferably introduced substantially parallel to the surface normal through the batch 17 in the direction of the underlying glass melt 16.

Substantially parallel in this context means a deviation of at most+/−10° from the surface normal. The batch layer is substantially not electrically conducting and is not heated by the microwave radiation, except in the immediate vicinity of the glass melt, particularly as a result of the measures described above for the cooling of the batch layer. Furthermore, like the charging duct 11, the waveguides are designed such that no microwave radiation can escape from the charging region.

The introductory apparatus for the microwave radiation consists preferably of an electrically conductive metal, i.e. a metal having a conductivity of >10⁷ S/m, which preferably is also corrosion- and temperature-resistant, preferably a noble metal selected from the group consisting of Pt, Rh or Ir and/or alloys thereof.

A waveguide of this kind may also accommodate a microwave-transparent, chemically resistant window, comprising, for example, SiO₂, BN and/or similar materials. Alternatively, the waveguide may also be flushed from above with gases such as air, oxygen, nitrogen, argon, or mixtures thereof, to prevent any gases ascending from the melting zone into the waveguide. Gases which arise due to the melting can be taken off through one or more air ducts 23. The geometry of such an air duct is dependent on the microwave used; for a power of 2.45 GHZ, for example, an air duct having a diameter of around 2 to 6 cm and a “start of sleeve” of 6 to 10 cm may be used; if the microwave used has a power of 500 MHz, the air duct diameter may be from 10 to 20 cm and the “start of sleeve” from 30 to 50 cm.

The last part of the microwave feed is preferably executed as a resonator. A resonator of this kind, fed in for example via a slot, may further increase the efficiency of the microwave fed in.

As can be seen from FIG. 1, the melting reaction zone 18 is accommodated directly below the batch layer, formed by the charging of the batch 17, and extends in a vertical direction between the glass melt 16 and the still-solid batch 17.

The vertical direction is understood, for example, as the direction in the figure that extends upward perpendicularly to a horizontal plane, this being, for example, the surface of an uncovered, flow-free glass melt 16. It is relative to this vertical direction that, in the context of this disclosure, the designations “above” or “beneath” and also “over” or “below” or “under” are based, insofar as they are spatial indications.

As a result of the targeted release of energy in the glass formation zone underneath the batch layer, without melting of the upper regions of the batch layer, in the charging region it is possible to achieve significant reduction in the emission of volatile constituents, such as, for example, alkali metal borate, boron, fluorine, CI, etc. An evaporation-condensation circulation is produced in the batch, analogous to the cold top in melting tanks.

The melting tank 10 is heated generally in the lower region by an electrical auxiliary heating (EAH) system, which possesses electrodes or electrode arrays 12a, 12b that provide electrical power for the electrical resistance heating of the melt 16. The EAH may be operated for example at 50 Hz or 10 KHz. An electrode array is understood to be a spaced row of electrodes which are arranged at equal distance from the charging zone; in the schematic drawing in FIG. 1, therefore, they are arranged in the same position relative to the charging zone.

Possible materials for the electrodes 12a, 12b are all of the materials typically used, such as platinum, tungsten, molybdenum, iridium or tin oxide or alloys thereof.

According to one preferred variant of the invention, in particular at least one electrode or electrode array 12a is arranged beneath the charging zone.

The advantageous combination of the microwave-heated melting zone 18 with a resistance heater 12a accommodated in the region of the melting zone 18 and optionally also with a cooled wall region 14a according to one variant of the invention is beneficial for the entire melt volume and not just the melting zone. Firstly, the temperature distribution in the melt is very homogeneous. As a result of the charging of the cold batch in particular without resistance heating 12a, in accordance with the prior art, the melt in the charging region is significantly colder than the melt in the subsequent parts of the melting furnace. These measures produce an improvement in glass quality, particularly in terms of bubbles included in the glass.

The accommodation of the resistance heating 12a beneath the partition wall between melting zone 18 and the melting tank 10 itself, preferably assisted by cooling of one or both of the wall regions 14a and/or 14b, produces a change in the flow conditions by comparison with the arrangement known in the prior art, where the resistance heating is accommodated directly under the batch layer 17. In the charging region, an intensified local flow 22 is developed, which leads to better melting of the batch and better mixing and homogenizing of the glass melt in the melting region itself. As a result, there are fewer batch residues in the melt bath 16 and a more homogeneous glass can be obtained. Furthermore, the flow is advantageously assisted at the point 20a at which the glass melt submerges downwards as it flows back.

The molten glass 16 is discharged from the melting tank 10 through the outlet 19, optionally via a refining region, and is then transferred for shaping.

The apparatus of the invention and the process of the invention are particularly suitable for relatively large, continuously operated melting tanks, with a molten glass throughput, for example, of at least 0.5 t/d, 40 to 50 t/d or even up to 300 t/d. In general, the open surface of the glass melt in such glass tanks has an area of at least 10 m², for example 10 to 60 m², or even, according to some embodiments, an area of 150 m² or more. The process of the invention, however, is not confined to relatively large melting tanks of this kind, but instead is also advantageous with smaller melting tanks, having an open surface area of the glass melt of 2 or 3 m², for example. The present invention is advantageous particularly in relatively large glass tanks, as it is essential that the microwave radiation can be limited to as small a space as possible and does not extend to the entire top furnace of the melting tank.

The glass melt preferably has an electrical conductivity of at least 0.1 S/m and/or the batch has at most an electrical conductivity of 50 S/m, preferably at most 30 S/m, more preferably at most 20 S/m.

### Glass Compositions

Any mention in this description of a “glass composition” should be understood as referring to the oxide composition of the glass, of the glass-ceramic or of the glass ceramizable to glass-ceramic, after melting and/or refining. In the event of chlorides and fluorides being used as additional refining agents, the “glass composition” refers to the oxide composition of the glass, of the glass-ceramic or of the glass ceramizable to glass-ceramic, after melting and/or refining, including the metal chlorides and metal fluorides still present.

In other words, the “glass composition” is the combination of the oxides, chlorides and fluorides that is obtained after melting and/or refining. The glass compositions according to the invention may contain large amounts of SiO₂ and B₂O₃. As a result, high-quality glasses or glass-ceramics are obtainable. The glass compositions may in particular be borosilicate, aluminosilicate or boro-aluminosilicate glasses or lithium aluminium silicate glass-ceramics.

The glass compositions may comprise alkali metal oxides, for example Li₂O, Na₂O and K₂O, in amounts of less than 20%, less than 15%, less than 12%, less than 10% or less than 5% by weight. The glass compositions are optionally free of alkali metal oxides. In alternative embodiments, the amount of alkali metal oxides in the glass composition is at least 1% by weight. A low amount of alkali metal oxides advantageously contributes to low CO₂ solubility in the melt.

The glass compositions may comprise alkaline earth metal oxides, for example MgO, CaO, SrO and BaO, in amounts of less than 20%, less than 15%, less than 12%, less than 10% or less than 5% by weight. The glass compositions are optionally free of alkaline earth metal oxides. In alternative embodiments, the amount of alkaline earth metal oxides in the glass composition is at least 1% by weight.

The glass composition may contain SiO₂ in an amount of at least 48%, at least 55%, at least 65%, at least 70% or at least 75% by weight. The amount of SiO₂ may optionally be up to 90%, up to 87.5%, up to 85%, up to 82.5% or up to 80% by weight.

The glass composition may be a glass-ceramic. In the case of a glass-ceramic, the glass composition may contain nucleating agents, for example TiO₂ and/or ZrO₂. The total amount of TiO₂ and/or ZrO₂ may optionally be at least 2.0% or at least 2.5% by weight. The total amount of TiO₂ and/or ZrO₂ may optionally be less than 7.0% or less than 5.0% by weight. The glass composition may be, for example, a lithium aluminium silicate glass composition containing at least 2.0% by weight of Li₂O.

The glass composition may optionally contain Al₂O₃ in an amount of at least 1.5%, at least 5.0% or at least 10.0% by weight. The amount of Al₂O₃ may be up to 25.0%, up to 23.0%, up to 20.0% or up to 18.0% by weight. In certain embodiments, the amount of Al₂O₃ may be from 1.5% to 23.0%, from 5.0% to 20.0% or from 10.0% to 18.0% by weight.

Additionally or alternatively, the glass composition may contain B₂O₃ in an amount of at least 0.5%, at least 8.0% or at least 10.0% by weight. The amount of B₂O₃ may be up to 25.0%, up to 23.0%, up to 20.0%, up to 18.0%, up to 16.0% or up to 14.0% by weight. In certain embodiments, the amount of B₂O₃ may be from 0.5% to 20.0%, from 8.0% to 16.0% or from 10.0% to 14.0% by weight.

Many high-viscosity glass compositions contain significant amounts of SiO₂, Al₂O₃ and B₂O₃. The glass composition may optionally contain a total amount of SiO₂, Al₂O₃ and B₂O₃ of at least 75.0%, at least 78.0%, at least 80.0%, at least 82.0% or at least 85.0% by weight. The total amount of SiO₂, Al₂O₃ and B₂O₃ may be less than 97.0%, less than 93.5% or less than 90.0% by weight. The amount of SiO₂, Al₂O₃ and B₂O₃ may optionally be from 75.0% to 95.0%, from 78.0% to 92.5% or from 85.0% to 90.0% by weight.

In one embodiment, the glass composition may be a lithium aluminium silicate glass which contains 3.0% to 4.2% by weight of Li₂O, 19% to 23% by weight of Al₂O₃, 60% to 69% by weight of SiO₂, and optionally TiO₂ and/or ZrO₂, preferably 2.0% to 4.0% by weight of TiO₂ and/or ZrO₂.

The glass compositions may contain added refining agent, in which case the refining agent is selected from the list of Na₂SO₄, K₂SO₄, Li₂SO₄, MgSO₄, CaSO₄, SrSO₄, ZnSO₄, Sb₂O₃, As₂O₃, CeO₂, Cl⁻, F⁻ and SnO₂, or mixtures thereof. The stated refining agents may be used individually or as a combination of two or more refining agents. Refining agents are used in a concentration of 0.05% to 2%, 0.1% to 1% or 0.2% to 0.5% by weight, based on the total mass of the batch of raw materials.

In certain embodiments, the glass composition—alternatively or additionally to the compositions described above—may be described by the following compositional ranges.

In one embodiment, the glass composition may be a borosilicate glass containing the following components in % by weight:

| | |
|---|---|
| SiO₂ | 70.0 to 87.0 |
| B₂O₃ | 7.0 to 25.0 |
| Na₂O + K₂O | 0.5 to 9.0 |
| Al₂O₃ | 0 to 7.0 |
| CaO | 0 to 3.0 |

In one embodiment, the glass composition may be a borosilicate glass containing the following components in % by weight:

| | |
|---|---|
| SiO₂ | 70.0 to 86.0 |
| Al₂O₃ | 0 to 8.0, or 0 to 5.0 |
| B₂O₃ | 9.0 to 25.0 |
| Na₂O | 0.5 to 8.0, or 0.5 to 5.0 |
| K₂O | 0 to 1.0 |
| Li₂O | 0 to 2.0, or 0 to 1.0 |

In one embodiment, the glass composition may be a borosilicate glass containing the following components in % by weight:

| | |
|---|---|
| SiO₂ | 70.0 to 80.0, or 71.0 to 77.0 |
| Al₂O₃ | 3.0 to 8.0, or 3.5 to 8.0 |
| B₂O₃ | 9.0 to 15.0, or 9.0 to 12.0 |
| Na₂O | 5.5 to 8.0 |
| K₂O | 0 to 1.0, or 0.1 to 0.5 |
| Li₂O | 0 to 0.5, or 0 to 0.3 |
| CaO | 0 to 3.0, or 0 to 1.5 |
| BaO | 0 to 1.5 |
| F⁻ | 0 to 0.3 |
| Cl⁻ | 0 to 0.3 |
| MgO + CaO + | 0 to 2.0 |
| BaO + SrO | |

In another embodiment, the glass composition may be an alkali metal borosilicate glass containing the following components in % by weight:

| | |
|---|---|
| SiO₂ | 78.3 to 81.0 |
| Al₂O₃ | 3.5 to 5.3 |
| B₂O₃ | 9.0 to 13.0 |
| Na₂O | 3.5 to 6.5 |
| K₂O | 0.3 to 2.0 |
| CaO | 0 to 2.0 |

In an alternative embodiment, the glass composition may be an alkali metal borosilicate glass containing the following components in % by weight:

| | |
|---|---|
| SiO₂ | 55.0 to 85.0 |
| Al₂O₃ | 0 to 15.0 |
| B₂O₃ | 3.0 to 20.0 |
| Na₂O | 3.0 to 15.0 |
| K₂O | 3.0 to 15.0 |
| ZnO | 0 to 12.0 |
| TiO₂ | 0.5 to 10.0 |
| CaO | 0 to 0.1 |

In a further embodiment, the glass composition may contain the following components in % by weight:

| | |
|---|---|
| SiO₂ | 58.0 to 75.0 |
| Al₂O₃ | 18.0 to 25.0 |
| Li₂O | 3.0 to 6.0 |
| Na₂O + K₂O | 0.1 to 2.0 |
| MgO + CaO + BaO + ZnO | 1.5 to 6.0 |
| TiO₂ + ZrO₂ | 2.0 to 6.0 |

and optionally one or more of the oxides of Co, Ni, Fe, Nd and Mo, and optionally one or more refining agents selected from the group of SnO₂, chlorides, As₂O₅, Sb₂O₅, preferably 0.1% to 1.5% by weight of SnO₂, or preferably 0.1% to 1.5% by weight of As₂O₅, or preferably 0.1% to 1.5% by weight of Sb₂O₅.

In one embodiment, the glass composition may contain the following components in % by weight:

| | |
|---|---|
| SiO₂ | 58.0 to 65.0 |
| Al₂O₃ | 14.0 to 25.0 |
| B₂O₃ | 6.0 to 10.5 |
| MgO | 0 to 3.0 |
| CaO | 0 to 9.0 |
| BaO | 3.0 to 8.0 |
| ZnO | 0 to 2.0 |

where the sum total of MgO, CaO and BaO is from 8.0% to 18.0% by weight.

In a further embodiment, the glass composition may contain the following components in % by weight:

| | |
|---|---|
| SiO₂ | 50.0 to 68.0, or 55.0 to 68.0 |
| Al₂O₃ | 15.0 to 20.0 |
| B₂O₃ | 0 to 6.0 |
| Li₂O | 0 to 6.0 |
| Na₂O | 1.5 to 16.0, or 8.0 to 16.0 |
| K₂O | 0 to 5.0 |
| MgO | 0 to 5.0 |
| CaO | 0 to 7.0, or 0 to 1.0 |
| ZnO | 0 to 4.0, or 0 to 1.0 |
| ZrO₂ | 0 to 4.0 |
| TiO₂ | 0 to 1.0, or substantially free of TiO₂ |

In one embodiment, the (refined) glass or the (refined) glass-ceramic has fewer than 80 bubbles with a size of 0.1 mm to 0.2 mm per 10 kg of glass and/or fewer than 2 bubbles with a size of more than 0.2 mm per 10 kg of glass.

In one embodiment, the (refined) glass or the (refined) glass-ceramic has fewer than 80 bubbles with a size of 0.1 mm to 0.2 mm per 10 kg of glass, fewer than 40 bubbles with a size of 0.1 mm to 0.2 mm per 10 kg of glass, fewer than 10 bubbles with a size of 0.1 mm to 0.2 mm per 10 kg of glass, fewer than 5 bubbles with a size of 0.1 mm to 0.2 mm per 10 kg of glass, or fewer than 2 bubbles with a size of 0.1 mm to 0.2 mm per 10 kg of glass, and/or fewer than 2 bubbles with a size of more than 0.2 mm per 10 kg of glass.

In one embodiment, the (refined) glass or the (refined) glass-ceramic has at least 0.1 bubble with a size of 0.1 mm to 0.2 mm per 10 kg of glass, or at least 0.5 bubble with a size of 0.1 mm to 0.2 mm per 10 kg of glass, and/or at least 0.1 bubble with a size of more than 0.2 mm per 10 kg of glass.

### LIST OF REFERENCE SYMBOLS

10 Melting tank
11 Charging duct
12a, 12b Electrodes
13 Microwave radiation
14 Partition wall between charging region and top furnace of the melting tank
14a, 14b Cooling arrangement
15 Burner
16 Glass melt
17 Batch layer
18 Melting zone
19 Outlet
20, 20a, 21, 22 Flow vortices in the glass melt
23 Air duct

1-13. (canceled)

14. An apparatus for producing glass, comprising:
a charging region comprising at least one microwave-emitting source and at least one waveguide capable of guiding microwave radiation from a microwave generator into a vicinity of a batch layer, the charging region being designed such that no microwave radiation can leave the charging region; and
a melting region.

15. The apparatus of claim 14, wherein the at least one microwave-emitting source is at least one microwave radiator.

16. The apparatus of claim 14, wherein the charging region further comprises at least one cooling arrangement.

17. The apparatus of claim 14, further comprising at least one electrode or electrode array in the charging region below a wall.

18. The apparatus of claim 14, further comprising a horn-like or cylinder-like apparatus via which microwaves can be introduced substantially parallel to surface normals through the batch layer in a direction of an underlying glass melt.

19. The apparatus of claim 14, wherein a last part of a microwave feed is executed as a resonator.

20. The apparatus of claim 14, wherein the at least one microwave-emitting source comprises an introductory apparatus consisting of a corrosion- and temperature-resistant metal.

21. The apparatus of claim 20, wherein the corrosion- and temperature-resistant metal is a noble metal selected from the group consisting of platinum, rhodium, iridium, and alloys thereof.

22. The apparatus of claim 14, wherein directed emission takes place through the batch layer in a direction of a boundary layer to a glass melt.

23. A process for producing glass using an apparatus, the apparatus comprising a charging region comprising at least one microwave-emitting source and at least one waveguide capable of guiding microwave radiation from a microwave generator into a vicinity of a batch layer, the charging region being designed such that no microwave radiation can leave the charging region, and a melting region, the process comprising:
using microwave radiation for at least part of the energy supplied for melting and transforming a batch into a glass melt, wherein the microwave radiation used captures at least part of a transition between batch and unrefined melt, and the microwave radiation is coupled into a top region of the unrefined melt directly below the batch layer raising a temperature of the unrefined melt, wherein the microwave radiation is limited to the charging region.

24. The process of claim 23, wherein the microwave radiation is absorbed in a layer having a thickness of at most 100 mm.

25. The process of claim 24, wherein the thickness is at most 50 mm.

26. The process of claim 25, wherein the thickness is at most 20 mm.

27. The process of claim 23, wherein the glass melt has an electrical conductivity of at least 0.1 S/m and/or the batch has at most an electrical conductivity of 50 S/m.

28. The process of claim 27, wherein the batch has an electrical conductivity of at most 30 S/m.

29. The process of claim 28, wherein the batch has an electrical conductivity of at most 20 S/m.

30. The process of claim 23, wherein charging of the batch supplied is controlled such that, in the charging region, a continuous batch layer lying on the glass melt is formed and the batch layer extends to a bottom side of a wall.

31. The process of claim 23, wherein a CO₂-neutral glass melting process is provided in which an input of energy in a melting zone takes place with a combination of electrical heating and microwave irradiation, and electrical energy used for melting is provided with electrical power which has an at least neutral CO₂ balance.

32. The process of claim 23, wherein a throughput of molten glass is at least 0.5 t/d and/or wherein the glass melting is conducted continuously.
